(19) United States
(12) Patent Application Publication
(10) Pub. No.: US 2015/0229700 A1
(43) Pub. Date: Aug. 13, 2015

(54) PROTOCOL TRANSLATION FOR MEDIA PLAYER DEVICE CONTROL

(71) Applicant: QUALCOMM Incorporated, San Diego, CA (US)

(72) Inventors: Naveen Marigondanahalli Rudrappa, Bournemouth (GB); Allan Roger Timms, Gillingham (GB)

(73) Assignee: QUALCOMM Incorporated, San Diego, CA (US)

(21) Appl. No.: 14/178,954

(22) Filed: Feb. 12, 2014

(51) Int. Cl. H04L 29/08; H04L 29/06; G06F 9/54

(52) U.S. Cl. CPC H04L 67/10; G06F 9/54; H04L 67/42

(57) ABSTRACT

A network device that is distinct from a client device and a media player device receives a media player application programming interface (API) call from the client device. The network device translates the media player API call into a media player command that is compatible with a particular media protocol and provides the media player command for transmission to the media player device.

### TECHNICAL FIELD

The present embodiments relate generally to control of media player devices, and specifically to media protocol translation for the control of media player devices.

### BACKGROUND OF RELATED ART

A speaker (e.g., a wireless speaker) or other media player device may operate in accordance with one or more protocols (e.g., one or more peer-to-peer (P2P) protocols). It is desirable to control the media player device remotely, using controller software on a client device (e.g., a cell phone, tablet computer, laptop computer, or desktop computer) that communicates with the media player device through a network. However, the controller software on the client device may not be compatible with the one or more protocols (e.g., the one or more P2P protocols) used by the media player device.

### SUMMARY

In some embodiments, a method is performed at a network device that is distinct from a client device and a media player device. The network device receives a media player application programming interface (API) call from the client device and translates the media player API call into a media player command that is compatible with a particular media protocol. The network device also provides the media player command for transmission to the media player device.

In some embodiments, a network device includes one or more processors and memory storing one or more programs configured for execution by the one or more processors. The one or more programs include one or more instructions to translate a media player API call received from a client device into a media player command that is compatible with a particular media protocol. The one or more programs also include one or more instructions to provide the media player command for transmission to the media player device.

In some embodiments, a non-transitory computer-readable storage medium stores one or more programs configured for execution by one or more processors. The one or more programs include instructions to translate a media player API call received from a client device into a media player command that is compatible with a particular media protocol. The one or more programs also include instructions to provide the media player command for transmission to the media player device.

### BRIEF DESCRIPTION OF THE DRAWINGS

The present embodiments are illustrated by way of example and are not intended to be limited by the figures of the accompanying drawings.

FIGS. 1A-1C are block diagrams of systems in which a client device and media player device may communicate through a local network and may access the Internet or a wider network through a gateway device for the local network, in accordance with some embodiments.

FIG. 2 is a flowchart showing a method of media protocol translation in accordance with some embodiments.

FIG. 3 is a flowchart showing a method of media protocol translation in accordance with some embodiments.

FIG. 4A is a block diagram of a client device in accordance with some embodiments.

FIG. 4B is a block diagram of a gateway device in accordance with some embodiments.

FIG. 4C is a block diagram of a server in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

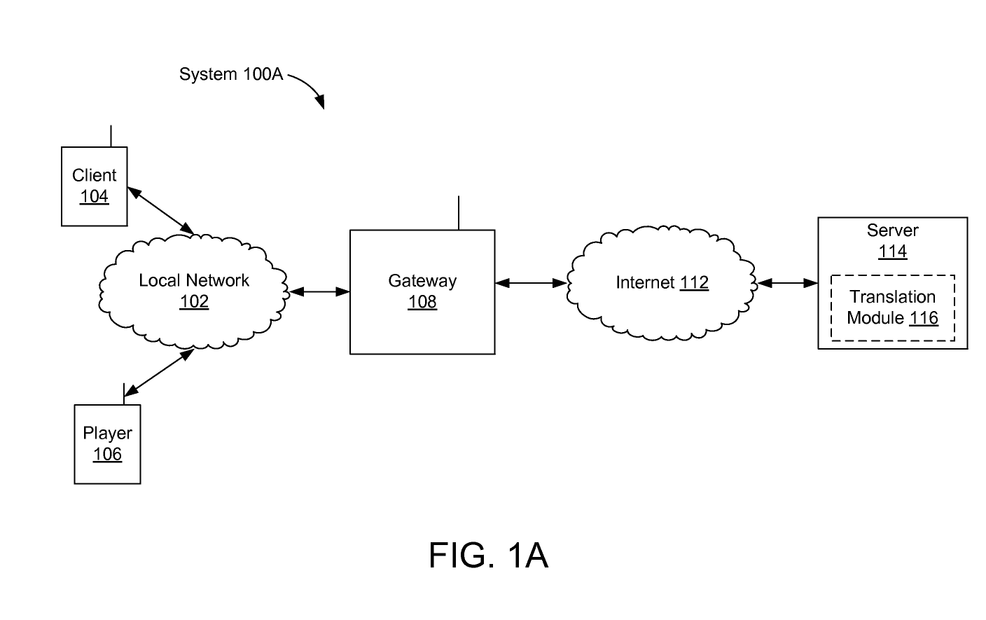

FIG. 1A is a block diagram of a system 100A in which a client device 104 and media player device 106 may communicate through a local network 102 in accordance with some embodiments. In some embodiments, the local network 102 is a wireless local area network (WLAN) (e.g., a WiFi network) and the client device 104 and media player device 106 are wireless devices. Alternatively, the local network 102 is a wired (i.e., wire-line) network. A gateway device 108 (e.g., a router) for the local network 102 provides access to the Internet 112 and/or to another wider network (e.g., a wide-area network (WAN), campus-area network (CAN), or metropolitan area network (MAN)). For example, the client device 104 and/or media player device 106 may communicate with a server 114 through the gateway device 108 and Internet 112 (or other network that is wider than the local network 102). If the local network 102 is wireless (e.g., a WLAN), than the gateway device 108 is a wireless device. For example, the gateway device 108 may be a wireless router (e.g., a wireless access point). Alternatively, if the local network 102 is wired, the gateway device 108 is a wire-line device.

Examples of the client device 104 include, but are not limited to, a cell phone, tablet computer, laptop computer, or desktop computer. Examples of the media player device 106 include, but are not limited to, a speaker, a set of speakers, or a television. While the client device 104, media player device 106, and gateway device 108 are shown as being separate from the local network 102, they may be considered part of the local network 102; in general, they are said to be on the local network 102. Also, while the system 100A is shown as including a single client device 104 and a single media player device 106 on the local network 102, it may include multiple client devices 104 and/or multiple media player devices 106 on the local network 102.

The client device 104 may be used to control the media player device 106. For example, the media player device 106 may be controlled by controller software (e.g., a media player application) running on the client device 104. The client device 104 may issue commands for the media player device 106 to play a media file, pause play of a media file, stop play of a media file, or perform another function related to a media file. Examples of media files include audio files (e.g., with formats such as MP3, AAC, WMA, WAV, BWF, AIFF, etc.) and video files (e.g., with formats such as MPEG-1, MPEG-2, MPEG-4, Flash Video, etc.).

The media player device 106 may use (e.g., operate in accordance with) one or more media protocols. In some embodiments, the media player device 106 may use one or more peer-to-peer (P2P) protocols. Examples of P2P protocols that the media player device 106 may use include, but are not limited to, Universal Plug and Play (UPnP), AllJoyn, and the cab protocol from Orb. The client device 104 may control the media player device 106 directly if the client device 104 is compatible with one of the media protocols used by the media player device 106 (e.g., if a media controller application or other controller software running on the client device 104 is compatible with one of the media protocols used by the media player device 106.) However, because of the existence of multiple media protocols, there is no guarantee of such compatibility. To increase the likelihood of such compatibility, the media player device 106 may be designed to use a number of protocols. However, design complexity increases as the number of protocols that the media player device 106 may use increases, as does the amount of memory to be included in the media player device 106 and thus the cost of the media player device 106.

Detection of the media player device 106 by the client device 104 presents a similar challenge. For example, the client device 104 may broadcast a message on the local network 102 for identifying any available media player devices 106 on the local network 102. The message prompts available media player devices 106 to respond and identify themselves to the client device 104. Once the client device 104 has detected the presence of a media player device 106 in this manner, it may control the media player device 106. However, the media player devices 106 on the local network 102 will not respond if they are not compatible with the protocol used for the message.

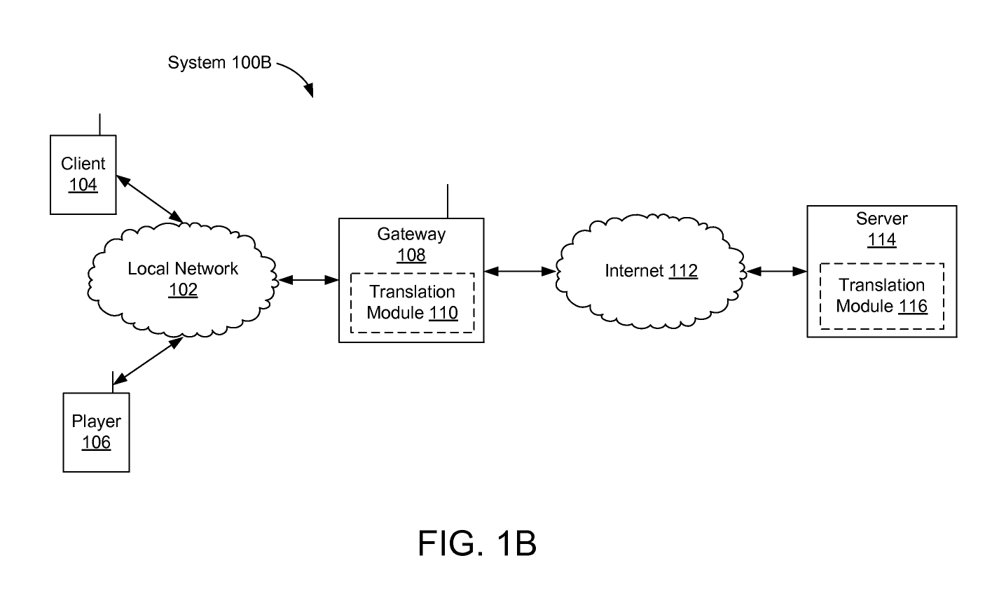

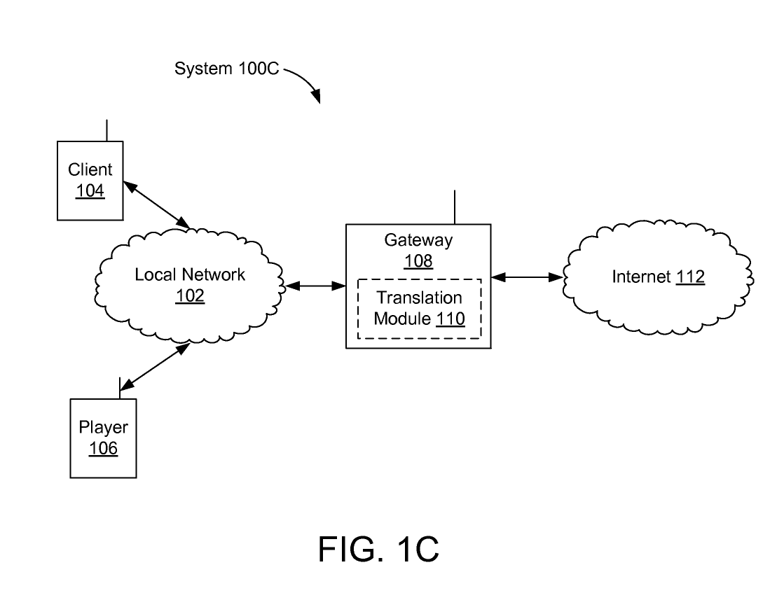

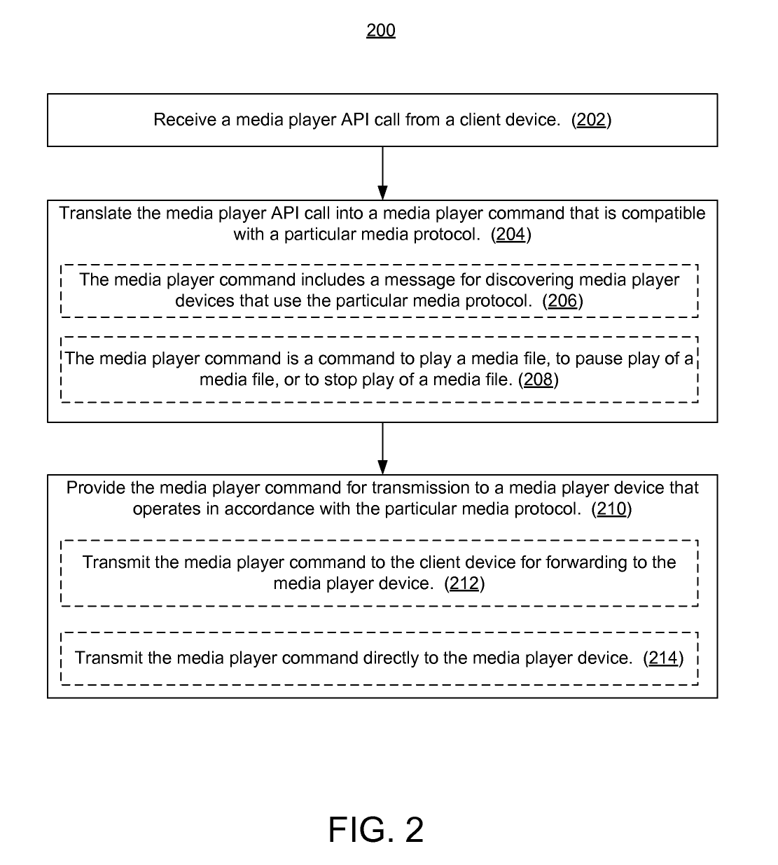

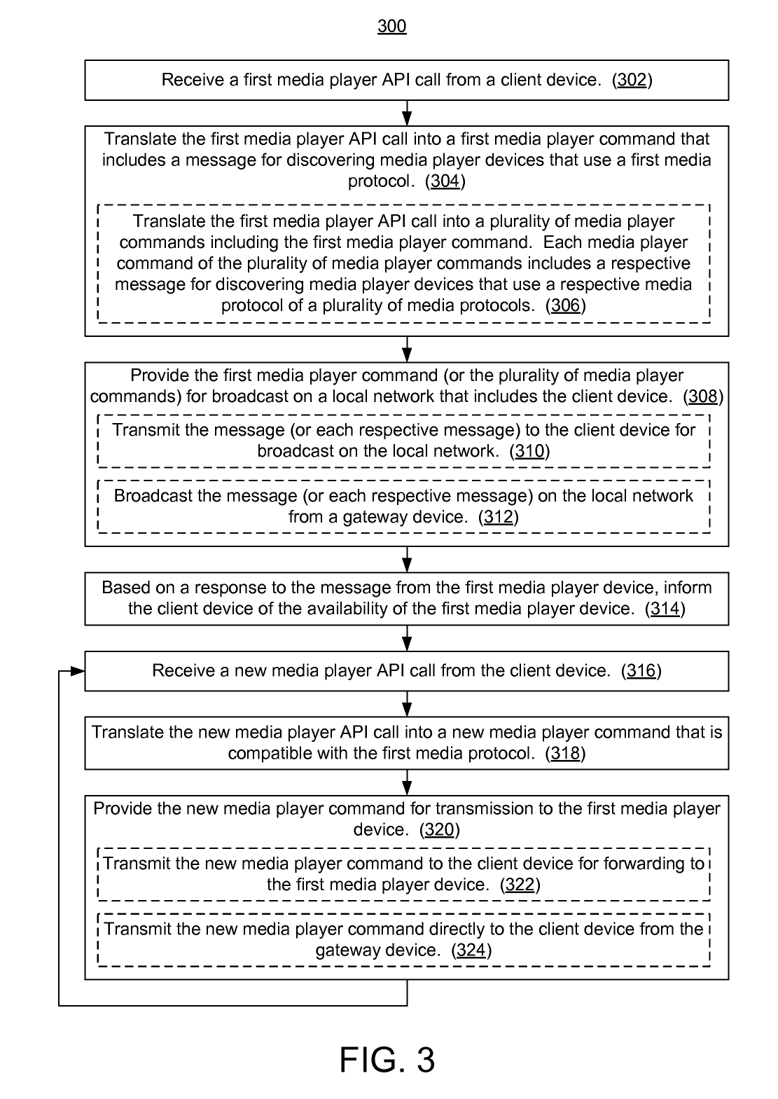

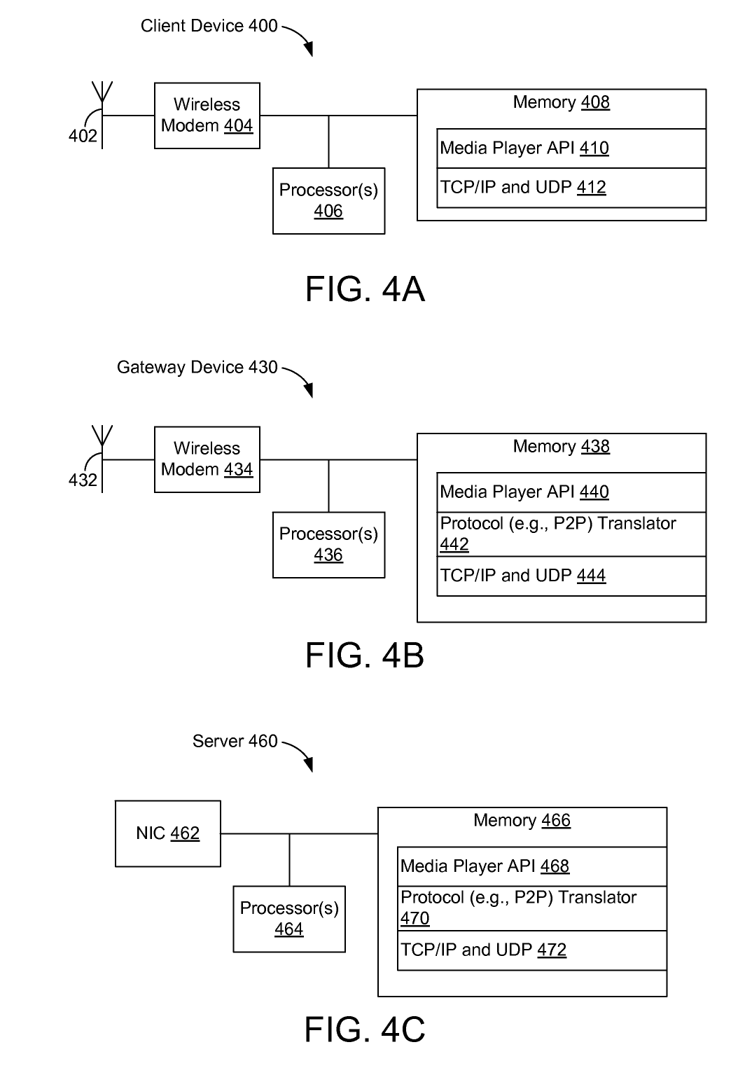

To alleviate these problems, a client device 104 may detect and/or control a media player device 106 by communicating with the media player device 106 using a translation module 116 on the server 114, regardless of whether the media player device 106 is compatible with controller software on the client device 104. The translation module 116 provides a media player application programming interface (API) (e.g., media player API 468, FIG. 4C). The client device 104 sends media player API calls to the server 114. For example, the client device 104 establishes a connection with the server 114 using Transmission Control Protocol/Internet Protocol (TCP/IP) and sends a media player API call to the server 114 accordingly. The translation module 116 converts the API call into a command that is compatible with a protocol used by the media player device 106 and sends the command to the client device 104, which then transmits the command to the media player device 106. The translation module 116 may be capable of translating the API call into a command that is compatible with any of a plurality of known media protocols, or into multiple commands, each of which is compatible with a respective media protocol of a plurality of media protocols. Examples of use of the translation module 116 are provided below in the methods 200 (FIG. 2) and 300 (FIG. 3).

In some embodiments, a translation module 110 is included in the gateway device 108, as shown for systems 100B (FIG. 1B) and 100C (FIG. 10). The translation module 110 functions in the same manner as the translation module 116. In the system 100B (FIG. 1B), the translation module 110 in the gateway device 108 may be a cached copy of the translation module 116 in the server 114. In the system 100C, the translation module 110 in the gateway device 108 replaces the translation module 116 in the server 114, which is omitted. Using the translation module 110 instead of the translation module 116 provides increased response time and increased privacy, and allows translation to be performed when connectivity to the Internet 112 (or other wider network) is not available.

In the examples of the systems 100A, 100B, and 100C (FIGS. 1A-10), the client device 104, media player device 106, and gateway device 108 are all on the same local network 102. Alternatively, the client device 104 may communicate with the media player device 106 through a first network (e.g., a personal area network (PAN)) and may communicate with the gateway device 108 through a second network (e.g., a local area network, such as a WLAN).

FIG. 2 is a flowchart showing a method 200 of media protocol translation in accordance with some embodiments. The method 200 is performed by a network device (e.g., by the server 114 or the gateway device 108, FIGS. 1A-1C).

A media player API call is received (202) from the client device 104. For example, if the method 200 is performed by the gateway device 108, the client device 104 sends the media player API call to the gateway device 108 through the local network 102. In another example, if the method 200 is performed by the server 114, the client device 104 sends the media player API call to the server 114 through the local network 102, gateway device 108, and Internet 112.

The media player API call is translated (204) into a media player command that is compatible with a particular media protocol (e.g., a particular P2P protocol). This translation is performed, for example, by the translation module 110 or the translation module 116. In some embodiments, the media player command includes (206) a message for discovering media player devices 106 that use the particular media protocol. In some embodiments, the media player command is (208) a command to play a media file, to pause play of a media file, to stop play of a media file, or to perform another function related to a media file.

The media player command is provided (210) for transmission to a media player device 106 that operates in accordance with the particular media protocol. In some embodiments, the media player command is transmitted (212) to the client device 104 for forwarding to the media player device 106. For example, the server 114 or gateway device 108 sends a packet containing the media player command to the client device 104, which then forwards the packet through the local network 102 to the media player device 106. Alternatively, the media player command is transmitted (214) directly to the media player device 106. For example, the gateway device 108 transmits a packet containing the media player command through the network 102 to the media player device 106, after having translated the media player API call into the media player command using the translation module 110. Providing the media player command thus may involve sending the media player command to the client device 104, or may be an internal operation within the gateway device 108 or server 114 in which the media player command is provided to a transmitter in the gateway device 108 or server 114.

FIG. 3 is a flowchart showing a method 300 of media protocol translation in accordance with some embodiments. The method 300 is performed by a network device (e.g., by the server 114 or the gateway device 108, FIGS. 1A-1C).

A first media player API call is received (302) from a client device 104. For example, if the method 300 is performed by the gateway device 108, the client device 104 sends the first media player API call to the gateway device 108 through the local network 102. In another example, if the method 300 is performed by the server 114, the client device 104 sends the first media player API call to the server 114 through the local network 102, gateway device 108, and Internet 112.

The first media player API call is translated (304) into a first media player command that includes a message for discovering media player devices 106 that use a first media protocol. In some embodiments, the first media player API call is translated (306) into a plurality of media player commands including the first media player command. Each media player command of the plurality of media player commands includes a respective message for discovering media player devices 106 that use a respective media protocol of a plurality of media protocols. Translation is performed, for example, by the translation module 110 or 116.

The first media player command is provided (308) for broadcast on a local network 102 that includes the client device 104. In some embodiments, the message is transmitted (310) to the client device 104 (e.g., using TCP/IP) for broadcast on the local network 102. For example, the server 114 or gateway device 108 sends a packet containing the message to the client device 104, which then broadcasts the packet on the local network 102 (e.g., using User Datagram Protocol (UDP) multicasting). Alternatively, the message is broadcast (312) on the local network 102 from the gateway device 108. For example, the gateway device 108 broadcasts a packet containing the message on the local network 102 (e.g., using UDP multicasting).

For some embodiments in which the first media player API call is translated (306) into a plurality of media player commands, each of which is compatible with a respective media protocol, the plurality of media player commands are provided for broadcast on the local network 102. For example, each respective message is transmitted (310) to the client device 104 for broadcast on the local network 102. The server 114 or gateway device 108 may send one or more packets containing the respective messages to the client device 104, which then broadcasts the one or more packets on the local network 102 (e.g., using UDP multicasting). Alternatively, each respective message is broadcast (312) on the local network 102 from the gateway device 108. The gateway device 108 may broadcast one or more packets containing the respective message on the network 102 (e.g., using UDP multicasting).

The operations 302, 304, and 308 are an example of the method 200 (FIG. 2).

Each available media player device 106 that uses the first media protocol (or uses one of the plurality of media protocols) responds to the first media player command (or to a respective one of the plurality of media player commands) with a message identifying itself. In some embodiments, the client device 104 collects these responses and forwards them to the gateway device 108 or server 114 for translation (e.g., by the translation module 110 or 116) into a format compatible with the client device 104 (e.g., compatible with controller software on the client device 104). Alternatively, the gateway device 108 and/or server 114 collect these responses. For example, the gateway device 108 may collect these responses and translate them using the translation module 110. In another example, the gateway device 108 may collect these responses and forward them to the server 114 for translation by the translation module 116. Furthermore, the translation module 110 and/or 116 may keep a record (e.g., a table) of available media player devices 106 and the protocols they use, as determined based on the responses. This record may be used to determine the protocol to use for translation of subsequent API calls into media player commands (e.g., as in operation 318, below).

Based on a response to the message from the first media player device 106, the client device 104 is informed (314) of the availability of the first media player device 106. If multiple media player devices 106 (e.g., using multiple respective media protocols) are present, the client device 104 is informed of the availability of the multiple media player devices 106. The client device 104 may then select one of the media player devices 106 on which to play media. For example, the client device 104 may display the available media player devices 106 on a user interface and receive a user input specifying one of the media player devices 106. In the example of the method 300, the first media player device 106 is selected.

A new media player API call is received (316) from the client device 104. For example, if the method 300 is performed by the gateway device 108, the client device 104 sends the new media player API call to the gateway device 108 through the local network 102. In another example, if the method 300 is performed by the server 114, the client device 104 sends the new media player API call to the server 114 through the local network 102, gateway device 108, and Internet 112.

The new media player API call is translated (318) into a new media player command that is compatible with the first media protocol. Translation is performed, for example, by the translation module 110 or 116.

The new media player command is provided (320) for transmission to the first media player device. In some embodiments, the new media player command is transmitted (322) to the client device 104 (e.g., using TCP/IP) for forwarding to the first media player device 106 (e.g., using TCP/IP). In some embodiments, the new media player command is transmitted (324) from the gateway device 108 directly to the client device 104 (e.g., using TCP/IP).

The operations 316, 318, and 320 are another example of the method 200 (FIG. 2).

In some embodiments, multiple iterations of the operations 316, 318, and 320 are performed in the method 300. For example, in a first iteration the new media player command may be a command to play a media file. In a second iteration the new media player command may be a command to pause or stop play of the media file. In a third iteration the new media player command may be a command to resume play of the media file, or to play another media file. These are merely some examples; other examples are possible.

Furthermore, in some embodiments the first media player device 106 may send out messages in response to events related to the processing of media files. The translation module 110 or 116 may be used to translate these messages into a format that the client device 104 (e.g., controller software on the client device 104) can understand. For example, the client device 104 may receive a message from the first media player device 106, send the message to the gateway device 108 or server 114 for translation, and receive a translation of the message from the gateway device 108 or server 114 in response. Alternatively, the first media player device 106 sends a message to the gateway device 108 or server 114, which translates the message and forwards the translated message to the client device 104.

While the methods 200 (FIG. 2) and 300 (FIG. 3) include a number of operations that appear to occur in a specific order, it should be apparent that the methods 200 and/or 300 can include more or fewer operations, which can be executed serially or in parallel. Performance of two or more operations may overlap and two or more operations may be combined into a single operation.

FIG. 4A is a block diagram of a client device 400, which is an example of a client device 104 (FIGS. 1A-1C) in accordance with some embodiments. The client device 400 includes one or more antennas 402 coupled to a wireless modem 404, and is thus a wireless device. Alternatively, the client device 400 may be a wire-line device, with the wireless modem 404 and one or more antennas 402 being replaced by a network interface card (NIC) and a suitable network connector. The client device 400 also includes one or more processors 406 and memory 408. The memory 408 includes a non-transitory computer-readable storage medium (e.g., Flash memory, a hard-disk drive, or other nonvolatile memory) storing one or more programs configured for execution by the one or more processors 406, such that the one or more programs include instructions configured for execution by the one or more processors 406. The one or more programs include a media player API 410, which includes instructions for generating the media player API calls of the methods 200 (FIG. 2) and/or 300. In some embodiments, the one or more programs also include instructions 412 for communicating using TCP/IP and UDP (and/or other suitable communication protocols).

FIG. 4B is a block diagram of a gateway device 430 in accordance with some embodiments. The gateway device 430 is an example of a gateway device 108 (FIGS. 1B-1C) and thus of a network device that may perform the methods 200 (FIG. 2) and/or 300 (FIG. 3). The gateway device 430 includes one or more antennas 432 coupled to a wireless modem 434, and is thus a wireless device. Alternatively, the gateway device 430 is a wire-line device, with the wireless modem 434 and one or more antennas 432 being replaced by a NIC and a suitable network connector. The gateway device 430 also includes one or more processors 436 and memory 438. The memory 438 includes a non-transitory computer-readable storage medium (e.g., Flash memory, a hard-disk drive, or other nonvolatile memory) storing one or more programs configured for execution by the one or more processors 436, such that the one or more programs include instructions configured for execution by the one or more processors 436. The one or more programs include a media player API 440 for processing media player API calls received from client devices 104 (e.g., client devices 400, FIG. 4A) and a protocol translator 442 for translating API calls into media player commands compatible with any of a plurality of media protocols (e.g., P2P protocols). The media player API 440 and protocol translator 442 together are an example of a translation module 110 (FIGS. 1B-1C). In some embodiments, the one or more programs also include instructions 444 for communicating using TCP/IP and UDP (and/or other suitable communication protocols). The one or more programs thus may include instructions for performing the methods 200 (FIG. 2) and/or 300 (FIG. 3).

FIG. 4C is a block diagram of a server 460 in accordance with some embodiments. The server 460 is an example of a server 114 (FIGS. 1A-1B) and thus of a network device that may perform the methods 200 (FIG. 2) and/or 300 (FIG. 3). The server 460 includes a NIC 462 and a suitable network connector (not shown). The gateway device 430 also includes one or more processors 464 and memory 466. The memory 466 includes a non-transitory computer-readable storage medium (e.g., Flash memory, a hard-disk drive, or other nonvolatile memory) storing one or more programs configured for execution by the one or more processors 464, such that the one or more programs include instructions configured for execution by the one or more processors 464. The one or more programs include a media player API 468 for processing media player API calls received from client devices 104 (e.g., client devices 400, FIG. 4A) and a protocol translator 470 for translating API calls into media player commands compatible with any of a plurality of media protocols (e.g., P2P protocols). The media player API 468 and protocol translator 470 together are an example of a translation module 116 (FIGS. 1A-1B). In some embodiments, the one or more programs also include instructions 472 for communicating using TCP/IP and UDP (and/or other suitable communication protocols). The one or more programs thus may include instructions for performing the methods 200 (FIG. 2) and/or 300 (FIG. 3).

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method, comprising:
at a network device distinct from a client device and a first media player device:
receiving a first media player application programming interface (API) call from the client device;
translating the first media player API call into a first media player command that is compatible with a first media protocol; and
providing the first media player command for transmission to the first media player device.

2. The method of claim 1, wherein the network device is selected from the group consisting of a server and a gateway device for a local network that includes the client device and the first media player device.

3. The method of claim 1, wherein the first media player device is selected from the group consisting of a speaker and a television.

4. The method of claim 1, wherein the first media protocol comprises a peer-to-peer protocol.

5. The method of claim 1, wherein the first media player command is selected from the group consisting of a command to play a media file, a command to pause play of a media file, and a command to stop play of a media file.

6. The method of claim 1, wherein the first media player command comprises a message for discovering media player devices that use the first media protocol.

7. The method of claim 6, wherein providing the first media player command for transmission to the first media player device comprises transmitting the message to the client device, wherein the client device is to broadcast the message on a local network.

8. The method of claim 6, wherein:
the network device comprises a gateway device for a local network that includes the client device and the first media player device; and
providing the first media player command for transmission to the first media player device comprises broadcasting the message on the local network from the gateway device.

9. The method of claim 6, further comprising, at the network device:
translating the first media player API call into a plurality of media player commands including the first media player command, wherein each media player command of the plurality of media player commands comprises a respective message for discovering media player devices that use a respective media protocol of a plurality of media protocols; and
providing the plurality of media player commands for broadcast on a local network that includes the client device.

10. The method of claim 9, wherein providing the plurality of media player commands for broadcast on the local network comprises transmitting each respective message to the client device, wherein the client device is to broadcast each respective message on the local network.

11. The method of claim 9, wherein:
the network device comprises a gateway device for the local network; and
providing the plurality of media player commands for broadcast on the local network comprises broadcasting each respective message on the local network from the gateway device.

12. The method of claim 6, further comprising, at the network device:
based on a response to the message from the first media player device, informing the client device of the availability of the first media player device.

13. The method of claim 12, further comprising, at the network device, after informing the client device of the availability of the first media player device:
receiving a second media player API call from the client device;
translating the second media player API call into a second media player command that is compatible with the first media protocol and comprises a command to play a media file; and
providing the second media player command for transmission to the first media player device.

14. The method of claim 1, further comprising, at the network device:
translating the first media player API call into a plurality of media player commands including the first media player command, wherein each media player command of the plurality of media player commands is compatible with a respective media protocol; and
providing the plurality of media player commands for transmission on a local network that includes the client device.

15. A network device, comprising:
one or more processors; and
memory storing one or more programs configured for execution by the one or more processors, the one or more programs comprising:
one or more instructions to translate a first media player application programming interface (API) call received from a client device into a first media player command that is compatible with a first media protocol; and
one or more instructions to provide the first media player command for transmission to a first media player device.

16. The network device of claim 15, wherein the one or more instructions to provide the first media player command for transmission to the first media player device comprise one or more instructions to transmit the first media player command to the client device, wherein the client device is to forward the first media player command to the first media player device.

17. The network device of claim 15, wherein the one or more instructions to provide the first media player command for transmission to the first media player device comprise one or more instructions to transmit the first media player command directly to the first media player device.

18. The network device of claim 15, wherein:
the first media player command comprises a message for discovering media player devices that use the first media protocol; and
the one or more programs further comprise:
one or more instructions to translate the first API call into a plurality of media player commands including the first media player command, wherein each media player command of the plurality of media player commands comprises a respective message for discovering media player devices that use a respective media protocol of a plurality of media protocols; and
one or more instructions to provide the plurality of media player commands for broadcast on a local network that includes the client device.

19. A non-transitory computer-readable storage medium storing one or more programs configured for execution by one or more processors, the one or more programs comprising:
one or more instructions to translate a first media player application programming interface (API) call received from a client device into a first media player command that is compatible with a first media protocol; and
one or more instructions to provide the first media player command for transmission to a first media player device.

20. The computer-readable storage medium of claim 19, wherein the one or more programs further comprise:
one or more instructions to translate the first API call into a plurality of media player commands including the first media player command, wherein each media player command of the plurality of media player commands comprises a respective message for discovering media player devices that use a respective media protocol of a plurality of media protocols; and
one or more instructions to provide the plurality of media player commands for broadcast on a local network that includes the client device.
